(19) United States
(12) Patent Application Publication
(10) Pub. No.: US 2010/0289912 A1
(43) Pub. Date: Nov. 18, 2010

(54) CAMERA ARRANGEMENT WITH IMAGE MODIFICATION

(75) Inventors: Darius Katz, Malmo (SE); Stefan Olsson, Lund (SE)

Correspondence Address: EDWARDS ANGELL PALMER & DODGE LLP, P.O. BOX 55874, BOSTON, MA, 02205, US

(73) Assignee: SONY ERICSSON MOBILE COMMUNICATIONS AB, Lund (SE)

(21) Appl. No.: 12/465,782

(22) Filed: May 14, 2009

(51) Int. Cl. H04N 5/228

(52) U.S. Cl. 348/222.1; 348/E05.031

(57) ABSTRACT

A camera arrangement and corresponding methods are provided. The camera arrangement in an embodiment comprises circuitry to analyze a recorded image in order to determine a gesture and to decide on a modification of the image based on the identified gesture.

### FIELD OF THE INVENTION

The present invention relates to camera arrangements with integrated image modification and corresponding methods. The term “camera arrangement”, in this respect, is intended to refer not only to dedicated camera arrangements, but also to camera arrangements integrated in other mobile electronic devices, for example camera arrangements integrated in mobile phones, personal digital assistants, portable gaming devices or laptop computers.

### BACKGROUND

In recent years, digital photography has widely replaced film photography. Pictures, i.e. images, taken with digital camera arrangements can be postprocessed for example on a computer. Such a postprocessing may comprise slight modifications of the recorded image, but also significant alterations or modifications to give the image a different impression. However, such postprocessing requires the use of a computer and corresponding image processing software, which is not always easy to operate. Moreover, in particular with the increasing use of digital camera arrangements integrated in mobile phones, it is often desirable to transmit an image for example to a friend, e.g. by SMS, MMS or email immediately after recording the image and still be able to modify the image somewhat.

### SUMMARY OF THE INVENTION

According to an embodiment, a camera arrangement is provided, comprising: a digital camera unit configured to digitally record at least one image, and analyzing circuitry configured to determine a gesture of a subject of the at least one recorded image and to decide on a picture modification depending on the determined gesture.

According to an embodiment, said analyzing circuitry may further be configured to modify said at least one image corresponding to the decided modification.

According to an embodiment, said camera unit may further be configured to record at least one further image, and wherein said analyzing circuitry is further configured to modify said at least one further image corresponding to said modification decided upon.

According to an embodiment, the camera arrangement may further comprise a user input device, wherein said analyzing circuitry is further configured to decide on said modification based on an input received from the user input device.

According to an embodiment, said analyzing circuitry may further be configured to decide on said modification based on a selected image recording mode.

According to an embodiment, said modification may comprise replacing a portion of a recorded image with a portion based on previously stored image material.

According to an embodiment, said portion of said recorded image may comprise a portion selected from the group consisting of a background of the recorded image, a clothes portion of a subject of the recorded image, and a frame portion of the recorded image.

According to an embodiment, said modification may comprise subjecting a portion of the image to an algorithm changing the appearance of the portion of the recorded image.

According to an embodiment, the portion of the recorded image may comprise a face portion of a subject of the image.

According to an embodiment, said algorithm may comprise an algorithm selected from the group consisting of a morphing algorithm and a blurring algorithm.

According to an embodiment, said modification may comprise a combined resize and recenter operation.

According to an embodiment, said gesture may be selected from the group consisting of a hand motion in front of a face of a subject of the recorded image, a drawing of a rectangle by a subject of the recorded image, a pulling of an ear of a head of a subject of the recorded image, a making of a plus sign with fingers of a subject of the recorded image, a salute made by a subject of the recorded image and a martial arts pose made by a subject of the recorded image.

According to an embodiment, the camera arrangement may be a portion of an electronic device selected from the group consisting of a mobile phone, a portable gaming device, a personal digital assistant, a smartphone and a laptop computer.

According to an embodiment, said analyzing circuitry may be configured to enhance a contrast of said at least one image prior to performing said analysis.

According to a further embodiment, a method is provided, comprising: recording at least one image, analyzing said at least one image to identify a gesture made by a subject of the at least one image, and deciding on a modification depending on said identified gesture.

According to an embodiment, said modification may comprise replacing a portion of a recorded image by a portion based on previously stored image material.

According to an embodiment, said modification may comprise performing an algorithm changing an appearance of a portion of a recorded image.

According to an embodiment, the method may further comprise enhancing a contrast of said at least one image prior to said analyzing.

According to an embodiment, the method may further comprise performing said modification with an image selected from the group consisting of said at least one image and a further recorded image.

It should be noted that the above described features may be freely combined with each other unless specifically noted to the contrary.

### BRIEF DESCRIPTION OF THE DRAWINGS

FIG. 1 shows a camera arrangement according to an embodiment.

FIG. 2 shows a method according to an embodiment.

FIG. 3 shows a method according to a further embodiment.

FIGS. 4A to 9 show pictures for explaining the functioning of some embodiments.

### DETAILED DESCRIPTION

In the following, various embodiments of the present invention will be described in detail with reference to the accompanying drawings. It is to be understood that the following description and drawings are given only for the purpose of illustration and are not to be taken in a limiting sense.

It is to be understood that in the drawings various elements are depicted in a manner to give a clear understanding of the respective embodiment to a person skilled in the art and are not necessarily drawn to scale. Also, different Figures, although showing the same or similar elements, are not necessarily to scale with each other.

It is to be noted that any couplings or connections shown between structural elements or blocks in the drawings may be realized both by direct connections, i.e. connections without intervening elements, and by indirect connections, i.e. connections via one or more intervening elements. Moreover, it is to be understood that while for the purpose of illustration functional blocks may be shown as separate units, unless noted to the contrary the corresponding functions may also be implemented in a common unit, for example a common circuit or chip.

It should be noted that describing an embodiment comprising a plurality of specific elements is not to be construed as indicating that all these elements are necessary for practicing the present invention. Instead, in other embodiments, fewer elements and/or alternative elements may be provided. On the other hand, additional elements to the ones shown in the drawings may be present.

Features of various embodiments may be combined with each other unless noted to the contrary.

The scope of the invention is not intended to be limited by the embodiments described hereinafter, but is intended to be limited only by the appended claims and equivalents thereof.

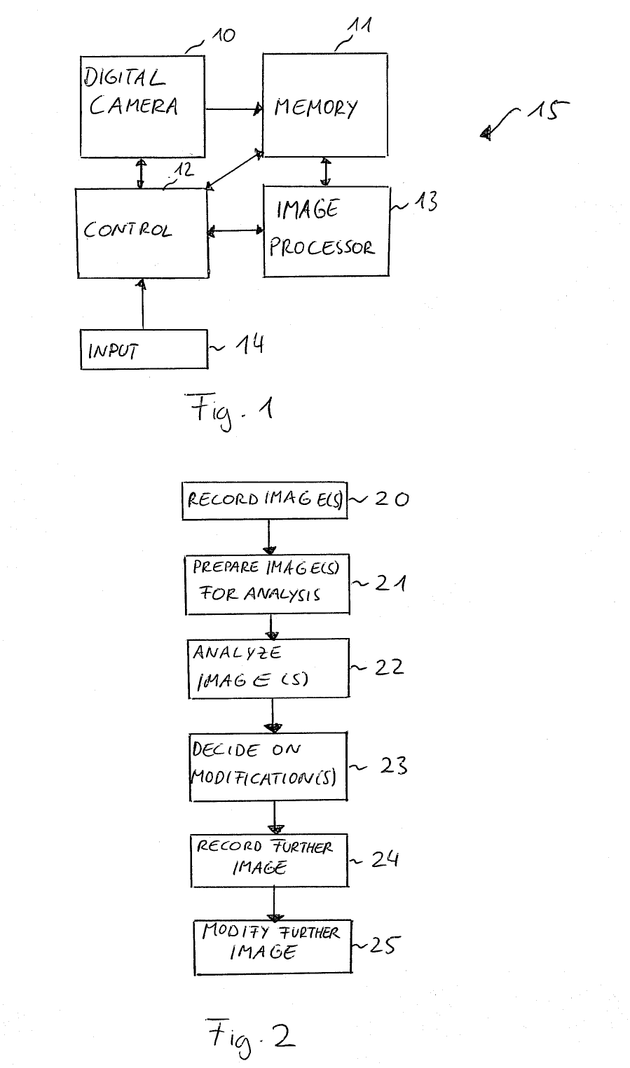

In FIG. 1, a block diagram of a camera arrangement 15 according to an embodiment of the present invention is shown. The camera arrangement 15 shown in FIG. 1 may be part of a dedicated digital camera, but also may be incorporated in any other electronic mobile device, for example a mobile phone, a personal digital assistant, a portable gaming device, a smartphone or a laptop computer. It should be noted that components of such a device not directly related to the functioning of the embodiment shown as explained hereinafter are not depicted. For example, if the camera arrangement 15 is part of a mobile phone, parts of the mobile phone related to the performing of telephone functions are not shown.

Camera arrangement 15 of the embodiment of FIG. 1 comprises a digital camera unit 10 for taking digital pictures, i.e. recording digital images. Digital camera unit 10 may be implemented in any conventional manner and typically comprises an image sensor, for example a CCD-sensor (charged-coupled device) or a CMOS-sensor (complementary metal oxide semiconductor) to convert light into electrical signals and one or more lenses to focus light on the image sensor. Images recorded by the image sensor may be stored in a memory 11. Memory 11 may comprise a flash-type memory, a random access memory, and/or other types of memory, and may be implemented as a built-in memory of camera arrangement 15, as a memory of a removable chip card or a combination thereof.

A control unit 12, which for example may comprise a microprocessor, may access memory 11, i.e. read from and write to memory 11, and control digital camera unit 10. Via an input 14 a user may make an input to influence the control exerted by control unit 12. For example, by pressing a specific button of input 14, a user may cause control unit 12 to control digital camera unit 10 to record an image. Other inputs may comprise various settings for recording images, for example exposure times, flash activation, apertures, resolution, selftimer activation or the activation of specific image recording modes, for example image modes for black and white shooting, night shots or also for picture modifications based on gestures of a subject to be photographed, which will be explained in some more detail in the following.

Camera arrangement 15 furthermore comprises an image processor 13 to process and analyze images recorded by digital camera 10 stored in memory 11. In a corresponding image recording mode, image processor 13 may prepare images for analysis and analyze them to identify specific predetermined gestures of a subject to be photographed, in particular a human being, although gestures of animals may also be recognized in some embodiments. Based on these gestures, specific image manipulations or modifications may be performed, example for which will be explained later. Image processor 13 is controlled by control unit 12 in the embodiment of FIG. 1 to perform the above-mentioned analysis and modifications in a corresponding image recording mode.

It should be noted that while a separate image processor 13 is shown in the embodiment of FIG. 1 as analyzing circuitry, in other embodiments the functions of image processor 13 may be performed by control unit 12, for example by using a microprocessor of control unit 12.

The modification of the image performed depending on an analyzed gesture may in some embodiments comprise a replacement of image parts by textures or image parts stored in memory 11, or may comprise a modification of parts of the picture using algorithms like morphing algorithms or blurring algorithms.

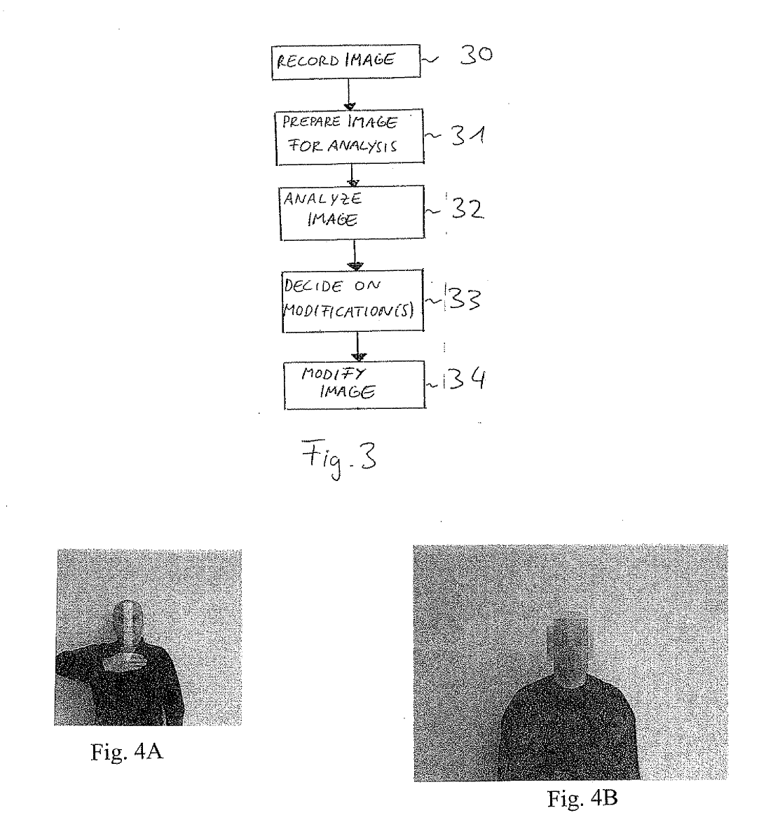

In some embodiments, after a gesture has been identified by analyzing the image, a further image is recorded, and on this further image the modifications are performed. An embodiment of a corresponding method is shown in FIG. 2. The method now described with reference to FIG. 2 may, but need not be, implemented in camera arrangement 15 discussed with reference to FIG. 1.

At 20, one or more images are recorded. With a single image, for example static gestures may be identified, while by recording and analyzing more than one image, also moving gestures, for example hand movements, may be identified. It should be noted that recording more than one image may be performed by recording a movie, a movie generally being a rapid succession of images, or also recording more than one still image.

At 21, the one or more images recorded at 20 are prepared for analysis. For example, a contrast of the image or images may be enhanced in order to facilitate the detection of gestures.

At 22, the image or images are analyzed to identify gestures.

At 23, depending on the identified gesture, it is decided if an image is to be modified according to one or more modifications. It should be noted that this decision is not necessarily solely based on the identified gestures, but may additionally depend on further factors like image recording mode selected or a user input. For example, if a gesture indicating a certain modification is identified, a user of the camera arrangement may be queried if the modification actually is to be performed.

At 24, a further image is recorded, and at 25, the further image is modified corresponding to the modification or modifications decided upon at 23. It should be noted that the further image may be one of a plurality of further images, for example images of a movie, all or some of which may be modified.

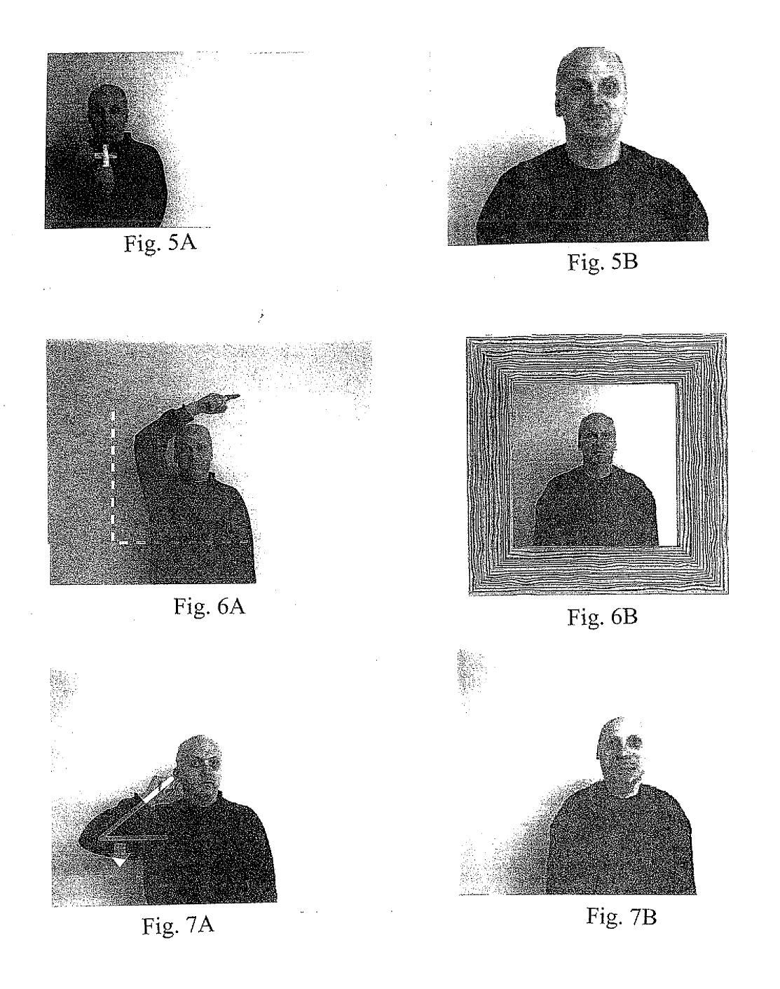

In other embodiments, the analyzed image is the same image which is then modified. An example of a method corresponding to such an embodiment is shown in FIG. 3.

At 30, at least one image is recorded. At 31, the recorded image is prepared for analysis. This may but need not be done with a duplicate of the image to preserve the original. The preparation for analysis may comprise a contrast enhancement, similar to what was explained with reference to FIG. 2.

At 32, the image is analyzed to identify a gesture of a subject of the image. At 33, depending on the determined gesture and possibly on other factors, similar to the embodiment of FIG. 2, like a user input, modifications are decided upon. At 34, the image is modified according to the decided modifications.

The image analysis at 22 of FIG. 2 and at 32 of FIG. 3 may comprise performing one or more algorithms like skin color identification, counting fingers of a hand of a subject, pattern recognition, neural networks, facial detection algorithms or body shape identification.

It should be noted that in the embodiments of FIGS. 2 and 3, steps may be omitted, or the order of steps may be changed. For example, the preparation of the image(s) for analysis may be omitted in some embodiments. In other embodiments, the decision on the modifications based on an image recording mode may be omitted, and the complete method may only be performed if a corresponding image recording mode is selected. In the embodiment of FIG. 2, the method from 20 to 22 in case of a plurality of images being recorded as 20 may be performed for each image separately one after the other.

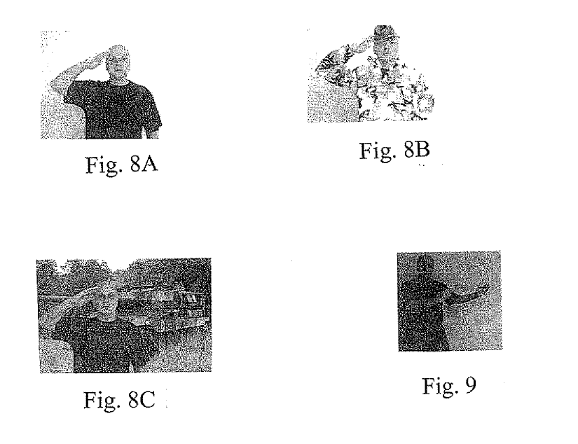

In the following, examples for predetermined gestures which may be identified for example at 22 of FIG. 2 or at 32 of FIG. 3 and modifications then performed will be explained with reference to FIGS. 4 to 9. FIGS. 4 to 7 in particular show examples which may be used in the method discussed with reference to FIG. 2, while the examples of FIGS. 8 and 9 rather pertain to the method of FIG. 3. However, this partitioning of the examples constitutes only one possibility, and gestures and modifications shown in FIGS. 4 to 7 may also be used in the embodiment of FIG. 3, and gestures and modifications shown in FIGS. 8 and 9 may also be used in the embodiment of FIG. 2.

In FIG. 4A a gesture is shown where a subject to be photographed moves a hand downward before his face. Such a gesture may for example be identified by recording a plurality of images at 20 in FIG. 2 in which the hand is at different positions and then reconstructing the movement during the analysis of the images at 22. In an embodiment, if such a gesture is identified, after the movement, for example a predetermined time after the movement, a further image is recorded, and in the further image the head of the subject is identified and blurred as shown in FIG. 4B such that the subject cannot be easily identified on the picture.

In FIGS. 5A and 5B, a further example is shown. In FIG. 5A, the subject to be photographed crosses two fingers to form a cross sign. When this gesture is identified, in an embodiment a further image is recorded, and this image is centered and resized such that the subject is prominently in the middle of the picture, as shown in FIG. 5B.

A further example is shown in FIGS. 6A and 6B. In FIG. 6A, an example of a gesture is shown where a subject draws a basically rectangular frame with his hand or finger. When such a gesture is identified, in an embodiment a further image is recorded, and a frame is added to the image as shown in FIG. 6B. The frame portion of the image shown in FIG. 6B may be a predefined pattern stored in a memory like memory 11 of FIG. 1. In such a case, the image may additionally be resized and/or centered such that the subject is positioned in the middle of the frame.

In FIG. 7 a further example is shown. As a predefined gesture, in FIG. 7A the subject of the image pulls his ear. This may be detected for example by detecting the characteristic position of the arm as indicated by a line in FIG. 7A.

If such a gesture is identified, a further image is recorded, and the face of the subject is then subjected to a morphing algorithm to provide a caricature-like image as shown in FIG. 7B.

A further example is shown in FIG. 8A. In this example, the gesture is a military salute. In an embodiment, when such a gesture is identified, the clothing of the person is replaced in the recorded image by a military outfit as shown in FIG. 8B. In another embodiment, the background of the image is changed to a military background as shown in FIG. 8C. These two possibilities of FIG. 8B and 8C may also be combined, i.e. the subject may be provided with a military outfit, and a military background may be inserted. The texture of the outfit and the military background may both be previously stored in the camera arrangement, for example in memory 11 of FIG. 1.

A further possible gesture is shown in FIG. 9. In FIG. 9, the subject is in a kung-fu-like pose. In such an embodiment, when the gesture is identified the subject's clothing may be replaced by a martial arts outfit, and/or the background may be replaced by a Far East background.

The examples of FIGS. 6, 8 and 9 are examples where portions of the recorded image are replaced by predefined textures, patterns or image portions. The examples of FIGS. 4 and 7 are cases where an algorithm, in the example shown a blurring algorithm or a morphing algorithm, is performed on a part of the picture.

The above-discussed gestures and modifications serve only as examples. Moreover, embodiments may implement one, more than one or all of these possibilities. All the modifications discussed may be performed as soon as the corresponding gesture is detected in some embodiments, and in other embodiments a photographer may be queried before performing the modification. The gesture identification and modifications as already explained in some embodiments may be performed only when the camera arrangement is set to a corresponding image recording mode, but in other embodiments may also be performed generally irrespective of an image recording mode set.

As can be seen from the above, a plurality of variations and modifications are possible, and therefore the present application is intended to be limited not by the above-described embodiments, but only by the appended claims and equivalents thereof.

What is claimed is:

1. A camera arrangement, comprising:
a digital camera unit configured to digitally record at least one image,
and
analyzing circuitry configured to determine a gesture of a subject of the at least one recorded image and to decide on a picture modification depending on the determined gesture.

2. The camera arrangement of claim 1, wherein said analyzing circuitry is further configured to modify said at least one image corresponding to the decided modification.

3. The camera arrangement of claim 1, wherein said camera unit is further configured to record at least one further image, and wherein said analyzing circuitry is further configured to modify said at least one further image corresponding to said modification decided upon.

4. The camera arrangement of claim 1, further comprising a user input device, wherein said analyzing circuitry is further configured to decide on said modification based on an input received from the user input device.

5. The camera arrangement of claim 1,
wherein said analyzing circuitry is further configured to decide on said modification based on a selected image recording mode.

6. The camera arrangement of claim 1, wherein said modification comprises replacing a portion of a recorded image with a portion based on previously stored image material.

7. The camera arrangement of claim 6, wherein said portion of said recorded image comprises a portion selected from the group consisting of a background of the recorded image, a clothes portion of a subject of the recorded image, and a frame portion of the recorded image.

8. The camera arrangement of claim 1, wherein said modification comprises subjecting a portion of the image to an algorithm changing the appearance of the portion of the recorded image.

9. The camera arrangement of claim 8, wherein the portion of the recorded image comprises a face portion of a subject of the image.

10. The camera arrangement of claim 9, wherein said algorithm comprises an algorithm selected from the group consisting of a morphing algorithm and a blurring algorithm.

11. The camera arrangement of claim 1, wherein said modification comprises a combined resize and recenter operation.

12. The camera arrangement of claim 1, wherein said gesture is selected from the group consisting of a hand motion in front of a face of a subject of the recorded image, a drawing of a rectangle by a subject of the recorded image, a pulling of an ear of a head of a subject of the recorded image, a making of a plus sign with fingers of a subject of the recorded image, a salute made by a subject of the recorded image and a martial arts pose made by a subject of the recorded image.

13. The camera arrangement of claim 1, wherein the camera arrangement is a portion of an electronic device selected from the group consisting of a mobile phone, a portable gaming device, a personal digital assistant, a smartphone and a laptop computer.

14. The camera arrangement of claim 1, wherein said analyzing circuitry is configured to enhance a contrast of said at least one image prior to performing said analysis.

15. A method, comprising:
recording at least one image,
analyzing said at least one image to identify a gesture made by a subject of the at least one image, and
deciding on a modification depending on said identified gesture.

16. The method of claim 15, wherein said modification comprises replacing a portion of a recorded image by a portion based on previously stored image material.

17. The method of claim 15, wherein said modification comprises performing an algorithm changing an appearance of a portion of a recorded image.

18. The method of claim 15, further comprising enhancing a contrast of said at least one image prior to said analyzing.

19. The method of claim 15, further comprising performing said modification with an image selected from the group consisting of said at least one image and a further recorded image.
